(19) United States
(12) Patent Application Publication
(10) Pub. No.: US 2025/0272866 A1
(43) Pub. Date: Aug. 28, 2025

(54) IMAGE ANALYSIS APPARATUS, IMAGE ANALYSIS METHOD, AND NON-TRANSITORY COMPUTER-READABLE MEDIUM

(71) Applicant: CANON KABUSHIKI KAISHA, Tokyo (JP)

(72) Inventor: Tomohiro SATO, Tokyo (JP)

(21) Appl. No.: 19/055,609

(22) Filed: Feb. 18, 2025

(30) Foreign Application Priority Data
Feb. 27, 2024 (JP) 2024-027873

(51) Int. Cl. G06T 7/62; G06T 7/00

(52) U.S. Cl. CPC G06T 7/62; G06T 7/0002; G06T 2207/20092; G06T 2207/30168

(57) ABSTRACT

An image analysis apparatus is provided. The apparatus presents an image of a determination-target crack detected from an inspection target to a user together with a plurality of reference images each showing a crack. The apparatus acquires user input for selecting two or more reference images among the plurality of reference images. The apparatus determines a width of the determination-target crack based on information indicating crack widths associated with the two or more reference images.

### BACKGROUND

### Technical Field

The present disclosure relates to an image analysis apparatus, a control method therefor, and a storage medium, and relates in particular to the detection of defects in a structure.

### Description of the Related Art

A technique has been proposed of, in order to make the inspection of structures more efficient, detecting defects in an image obtained by image-capturing a structure using a camera. Such a technique is expected to reduce the burden of inspecting infrastructure such as highways and railways. For example, defects such as concrete cracks in a bridge, a tunnel wall, or the like can be examined on a captured image. Furthermore, defect attributes, such as crack width, need to be determined in order to analyze defects. The distribution and change over time of defects such as cracks can be ascertained by using such a technique.

Japanese Patent Laid-Open No. 2020-201713 discloses a technique for assisting a user in determining the width of a crack in an image. In the method disclosed in Japanese Patent Laid-Open No. 2020-201713, the user draws a line along a crack that the user has discovered in a captured image. On the other hand, a crack scale that is an image simulating cracks of various widths is generated. As a result of this crack scale being superimposed on the captured image of the measurement target, the user can easily determine the width of the crack that the user has discovered.

On the other hand, various techniques have also been proposed for automatically detecting defects by image processing. Japanese Patent Laid-Open No. 2013-195074 discloses a method for automatically detecting a crack and the width thereof from an image.

### SUMMARY

According to an embodiment of the present disclosure, an image analysis apparatus comprises one or more memories storing instructions and one or more processors that execute the instructions to: present an image of a determination-target crack detected from an inspection target to a user together with a plurality of reference images each showing a crack; acquire user input for selecting two or more reference images among the plurality of reference images; and determine a width of the determination-target crack based on information indicating crack widths associated with the two or more reference images.

According to another embodiment of the present disclosure, an image analysis apparatus comprises one or more memories storing instructions and one or more processors that execute the instructions to: present an image of a determination-target defect detected from an inspection target to a user together with a plurality of reference images each showing a defect; acquire user input for selecting a reference image from among the plurality of reference images; and determine an attribute value of the determination-target defect based on a defect attribute value associated with the reference image conforming to the user input, wherein each of the plurality of reference images is an image of a defect extracted from a captured image, and is associated with information indicating an attribute value of the defect.

According to still another embodiment of the present disclosure, an image analysis method comprises: presenting an image of a determination-target crack detected from an inspection target to a user together with a plurality of reference images each showing a crack; acquiring user input for selecting two or more reference images among the plurality of reference images; and determining a width of the determination-target crack based on information indicating crack widths associated with the two or more reference images.

According to yet another embodiment of the present disclosure, a non-transitory computer-readable medium stores a program executable by a computer to perform a method comprising: presenting an image of a determination-target crack detected from an inspection target to a user together with a plurality of reference images each showing a crack; acquiring user input for selecting two or more reference images among the plurality of reference images; and determining a width of the determination-target crack based on information indicating crack widths associated with the two or more reference images.

Further features of the present disclosure will become apparent from the following description of exemplary embodiments with reference to the attached drawings.

### BRIEF DESCRIPTION OF THE DRAWINGS

FIG. 1 is a functional configuration diagram of an image analysis apparatus according to one embodiment.

FIG. 2 is a hardware configuration diagram of the image analysis apparatus according to one embodiment.

FIGS. 3A to 3C are schematic diagrams of UIs for correcting detection results.

FIGS. 4A to 4C are diagrams illustrating an example of a crack line. FIGS. 5A and 5B are diagrams for describing an example of a method for generating image fragments.

FIGS. 6A to 6C are flowcharts of an image analysis method according to one embodiment.

FIG. 7 is a diagram illustrating an example of an image fragment database.

FIG. 8 is a diagram for describing a method for increasing the number of image fragments.

FIG. 9 is a flowchart of an image analysis method according to one embodiment.

FIG. 10 is a schematic diagram of a UI for determining an attribute value of a defect.

### DESCRIPTION OF THE EMBODIMENTS

Hereinafter, embodiments will be described in detail with reference to the attached drawings. Note, the following embodiments are not intended to limit the scope of the disclosure. Multiple features are described in the embodiments, but limitation is not made to an embodiment that requires all such features, and multiple such features may be combined as appropriate. Furthermore, in the attached drawings, the same reference numerals are given to the same or similar configurations, and redundant description thereof is omitted.

There are cases in which defects are found to be erroneously detected or undetected even if an automatic detection technique is used. In such a case, a user knowledgeable in inspection manually adds or deletes a defect such as a crack, or corrects a defect attribute such as crack width. Upon adding a crack, the user draws a line along the crack in an image by operating a mouse, and specifies a crack width with a numerical value, for example. In this case, as is the case when measuring crack width by applying a crack scale to a wall surface at an inspection site, the user would have to visually perform measurement work and input numerical values successively for a large number of cracks present in an image covering a wide area. In such a manner, user work load still remains great even if defects are automatically detected.

One embodiment according to the present disclosure can reduce user work load in work of detecting defects.

An image analysis apparatus according to one embodiment can assist the determination of an attribute value of a defect detected in an image of an inspection target. The type of defect is not particularly limited. For example, cracks, delamination, flaking, rebar exposure, rust, rust stain, water leakage, water dripping, sand streaks, corrosion, damage (loss), efflorescence, cold joints, deposit, etc., can be mentioned as examples of defects. Furthermore, width, length, area, etc., can be mentioned as defect attribute values, and the width of a crack, the length of a crack, the area of flaking or efflorescence, etc., can be mentioned as specific examples of defect attribute values.

In the following embodiment, as one example, crack width is determined based on user input. In particular, the following embodiment can facilitate work by a user for inputting, to the image analysis apparatus, the maximum crack width of a crack that has been discovered and additionally specified by the user. In a specific example, an image fragment corresponding to a crack with unknown width that has been additionally specified in a captured image and an image fragment of the same resolution that has been prepared in advance and that corresponds to a crack with known width are arranged on a user interface (UI). Furthermore, the user visually compares the relative differences between these image fragments, whereby the maximum width of the crack can be registered to the image analysis apparatus. Furthermore, on this UI, the image fragments can be displayed in a layout that is suitable for comparison. Furthermore, in the following, an embodiment will be described in which the image analysis apparatus automatically detects cracks, and the user then edits the detection results so as to add a crack. That being said, the image analysis apparatus does not necessarily have to detect defects automatically.

### System Configuration

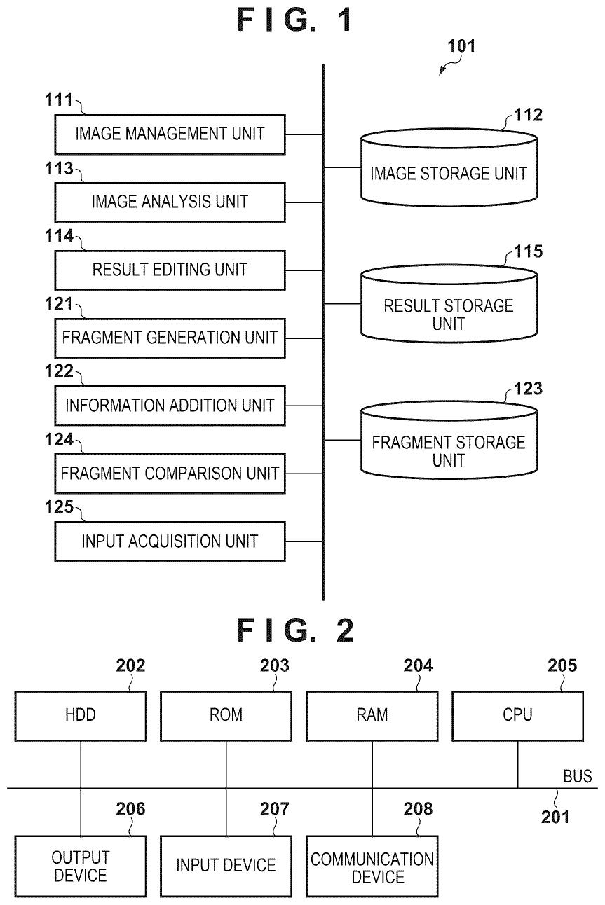

FIG. 1 illustrates an example of a configuration of the image analysis apparatus according to one embodiment, which detects defects in a structure. An image analysis apparatus 101 can include the units illustrated in FIG. 1.

An image management unit 111 manages captured images. The image management unit 111 can control the input and output of an image of an inspection target captured by a user. An image storage unit 112 stores captured images input by the image management unit 111.

An image analysis unit 113 detects defects from the image of the inspection target by image analysis processing. Furthermore, the image analysis unit 113 can determine attribute values of the defects by image analysis processing. While the specific method therefor is not particularly limited, the method disclosed in Japanese Patent Laid-Open No. 2013-195074 can be used, for example. Also, the image analysis unit 113 may execute the defect detection processing using AI or a neural network.

A result editing unit 114 edits the results of the detection of defects by the image analysis unit 113 based on user input. For example, the result editing unit 114 can add, delete, or modify defects. Specifically, an input acquisition unit 125 can acquire user input indicating the position of a crack additionally detected by the user in the image of the inspection target. The result editing unit 114 can add a defect in accordance with such user input. A result storage unit 115 stores information about defects detected by the image analysis unit 113 or edited by the result editing unit 114.

A fragment generation unit 121 generates image fragments showing a defect. From the image of the inspection target, the fragment generation unit 121 can extract portions of a defect as image fragments. For example, from the image of the inspection target, the fragment generation unit 121 can generate a plurality of image fragments each including a part of a defect detected from the inspection target. For example, in a case in which the defect is a crack, the fragment generation unit 121 generates, from the image of the inspection target, a plurality of image fragments each containing a part of the crack detected from the inspection target. Furthermore, the fragment generation unit 121 can generate image fragments that show defects and that are to be used as the later-described reference images. For example, the fragment generation unit 121 can generate image fragments to be used as reference images based on existing defect detection results.

A fragment comparison unit 124 presents an image of a determination-target defect detected from the inspection target to the user together with a plurality of reference images each showing a defect. The fragment comparison unit 124 can provide a UI for determining an unknown attribute value of the determination-target defect by comparing images. As a result of the user performing input on this UI, the unknown width of a determination-target crack can be determined by comparing image fragments. In one embodiment, each of the plurality of reference images is an image of a defect extracted from a captured image. Furthermore, each of the reference images is associated with information indicating an attribute value of the defect.

An input acquisition unit 125 acquires user input for selecting a reference image from among the plurality of reference images presented by the fragment comparison unit 124. An information addition unit 122 determines an attribute value of the determination-target defect based on a defect attribute value associated with the reference image conforming to the user input. In one embodiment, two or more reference images are selected from among the plurality of reference images. In addition, the information addition unit 122 determines the width of the determination-target crack based on information indicating crack widths associated with the two or more reference images conforming to the user input. Furthermore, the information addition unit 122 can associate, with an image fragment, information indicating a defect attribute value. For example, the information addition unit 122 can add information about crack angle or width to an image fragment.

A fragment storage unit 123 stores, as reference images, image fragments showing defects. The fragment storage unit 123 can store, as the reference images, image fragments having information indicating a defect attribute value associated therewith. For example, the fragment storage unit 123 can store the reference images together with information indicating the orientations and widths of the cracks shown in the reference images.

### Computer Hardware Configuration

The image analysis apparatus according to the present embodiment can be realized by a computer including one or more processors and one or more memories. FIG. 2 illustrates an example of a hardware configuration of such a computer. Processing for viewing image data and detection results, and of various settings, etc., is realized by an application program running on an operating system (OS). Such an application program is stored in an HDD 202 or a ROM 203. A CPU 205 reads the OS and the application program from the HDD 202 or the ROM 203, and loads the OS and the application program into a RAM 204. Then, the CPU 205 executes the application program, whereby various types of processing according to the present embodiment are realized. The functions of the units illustrated in FIG. 1, etc., can be realized by a processor such as the CPU 205 executing one or more programs stored in a memory such as the RAM 204, the ROM 203, or the HDD 202.

The application program can acquire user input from an input device 207, which is a mouse, a touch panel, and/or the like connected to the computer. Furthermore, the application program can display processing results on an output device 206 by outputting information to the output device 206. Thus, desired UIs can be displayed on the output device 206. Furthermore, via a communication device 208, the application program communicates with another apparatus connected to a network, such as a computer, a server, or a device. The above-described pieces of hardware are mutually connected via a bus 201. The application program can control such hardware via the bus 201.

As described above, the functions of the image analysis apparatus 101 illustrated in FIG. 1 can be realized by a computer. On the other hand, some or all functions of the image analysis apparatus 101 may be realized by dedicated pieces of hardware. Also, the image analysis apparatus according to one embodiment may be formed from a plurality of information processing apparatuses that are connected via a network, for example. That is, the image analysis apparatus 101 may be realized on-premise or in the cloud.

### Workflow of Detection of Defects in Structure

Before describing operations of the image analysis apparatus according to one embodiment, an example workflow of image-analysis-based detection of defects in a structure will be described. In this example, concrete in a bridge pier, a tunnel wall, or the like of a highway, a railway, or the like is subjected to defect detection. Furthermore, in this example, captured images obtained using a typical digital camera are used for defect detection.

It is often difficult for an on-site worker capturing an image of a structure to obtain a single image that has an image resolution high enough to recognize defects and also includes the entire inspection area. Thus, the worker often repeats the work of capturing an image of a part of the inspection area while gradually moving in the vertical and horizontal directions. Subsequently, one combined image is obtained by connecting the obtained images while executing processing such as enlargement, size reduction, rotation, projection conversion, color adjustment, and/or obstacle removal on the obtained images.

Such a combined image is generated for each part of the structure. The worker may repeat the above-described work in accordance with the number of pieces constituting the drawing of the structure. For example, in a case in which the inspection target is a pier constituting a bridge and the pier has a rectangular cross-section, one set of four images for “XX Bridge, Pier 1” is prepared by repeating the above-described work for each of the four side surfaces.

Subsequently, image-analysis-based detection of defects in the structure can be executed for each combined image. In contrast to the method of manually recording defects while looking at images, defects may be erroneously detected or remain undetected when image analysis is used. Thus, the user visually checks and corrects defects using an image analysis apparatus. Note that the image analysis apparatus that the user uses to correct defects may be the same apparatus as that performing the image analysis or may be a different apparatus. Subsequently, the image analysis apparatus can determine the degree of deterioration of the inspection target based on the defect detection results. Furthermore, the image analysis apparatus can determine a change in a defect over time based on a comparison with past defect detection results. Specifically, the image analysis apparatus may determine a change in the width of a crack.

In a case in which a crack is detected as a defect, a detection result can be represented using vertex coordinates of a polyline indicating the crack. In addition, the image analysis apparatus can determine the length and width of the crack based on the detection result of the crack. Furthermore, the image analysis apparatus can create an inspection report based on such detection results. For example, the image analysis apparatus can create an examination report by superimposing a crack detected in such a manner on a captured image. Furthermore, the image analysis apparatus can include, in the examination report, a determination result such as the width of the crack and/or a change in the crack over time.

### Example of UIs for Editing Defect Detection Results

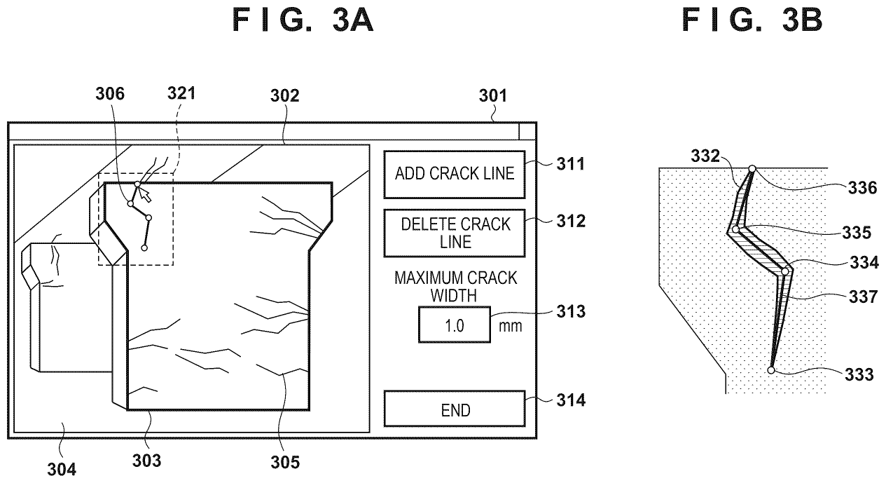

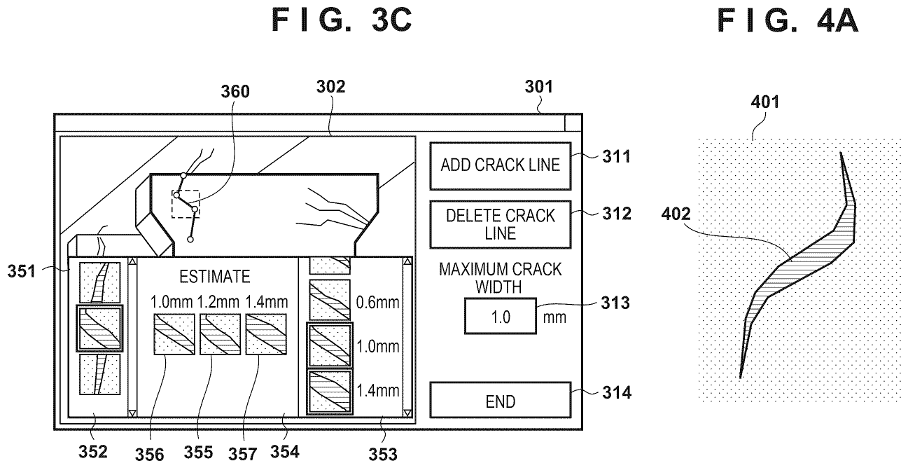

FIGS. 3A to 3C are schematic diagrams of UIs for editing defect detection results. The result editing unit 114 and the fragment comparison unit 124 can present such UIs to the user via the output device 206. Furthermore, the input acquisition unit 125 can acquire user input performed on the UIs via the input device 207.

FIG. 3A illustrates an editing screen 301 for editing defect detection results. The result editing unit 114 can generate such a UI. The editing screen 301 includes an image display pane 302. An image of an inspection target is displayed in the image display pane 302. The image of the inspection target may be the above-described combined image. This image may include not only an inspection target 303, which is a pier or the like, but also non-inspection-target objects 304 such as a deck, a pier behind, and the ground. The user checks the image and detection results in the image display pane 302. Furthermore, the user edits crack detection results in the image display pane 302 using the input device 207. The user can edit detection results by operating a mouse or a touch panel. For example, while checking a crack 305, etc., correctly detected from the inspection target, the user can add a new crack line 306 indicating a previously undetected crack that has been discovered visually.

FIG. 3B is an enlarged view of the portion of the image display pane 302 indicated by a frame 321. In order to add a crack line, the user presses an add button 311. Then, the user specifies coordinates along a crack 332 that can be visually discovered in the image. For example, the user can specify the coordinates of each of points 333 to 336 by clicking on the mouse. Thus, a polyline-shaped crack line 337 corresponding to the crack discovered by the user is added.

Furthermore, the user can input the width of the added crack line. In the following example, the width of a crack refers to the maximum width (referred to in the present description as “maximum crack width”) among crack widths at different positions along the crack. For example, the user may use a keyboard and manually input, to an input field 313, the maximum crack width value for the crack corresponding to the added crack line 337. On the other hand, in the present embodiment, the maximum crack width can be determined according to the later-described method in order to reduce the user's burden of inputting the maximum crack width.

Note that the user can press the add button 311 again and repeat the same work to add second and subsequent crack lines. Furthermore, in order to delete a crack line, the user can press a delete button 312. Subsequently, the user can delete a crack line by specifying the crack line by a mouse click or the like. Thus, the user can delete an existing crack line that was detected by image analysis or a crack line that the user has added. In such a manner, the user can repeatedly perform, on an image, the addition of a crack line (undetected crack line) that was not detected by image analysis and the deletion of a crack line (erroneously detected crack line) that was erroneously detected by image analysis. The user presses an end button 314 when editing is complete. Then, the editing result is stored and editing work ends. In this case, the result storage unit 115 can store information indicating the edited crack line and the maximum crack width thereof.

FIG. 3C is a schematic diagram of a UI used to determine the maximum crack width. The fragment comparison unit 124 can generate such a UI. As described above, the information addition unit 122 determines the width of a determination-target crack. In one embodiment, the determination-target crack is a crack detected by the user, or in other words, a crack corresponding to a crack line added by the user. In the following, a method for determining the maximum crack width of a crack line added by the user will be described.

In the editing screen 301 illustrated in FIG. 3C, a specification panel 351 is further displayed. The specification panel 351 is not displayed in the initial state. The specification panel 351 is displayed in accordance with user input. For example, the specification panel 351 may be displayed in order to specify the maximum crack width when a new crack line 360 has been added by the user according to the above-described method. Furthermore, the specification panel 351 may be hidden again when the specification of the maximum crack width is finished.

The specification panel 351 includes selection panes 352 and 353, and a comparison display pane 354. In the selection pane 352, one or more image fragments corresponding to a crack line added by the user are displayed. In FIG. 3C, three image fragments corresponding to the crack line 360 are displayed as a list in the selection pane 352. In this example, the crack width in each image fragment is unknown. The method for generating image fragments corresponding to a crack line will be described later. The user selects, from among the image fragments displayed in the selection pane 352, an image fragment for which crack width is to be determined. To make this possible, the result editing unit 114 receives a select operation performed by the user via the input device 207. The user can select an image fragment by operating the mouse or the touch panel. In this example, the maximum crack width of a crack is to be determined. Thus, the user can select an image fragment showing the widest crack among the plurality of image fragments.

The fragment comparison unit 124 presents, as an image of the determination-target crack, the image fragment selected by the user from among the plurality of image fragments corresponding to the crack line. In the example in FIG. 3C, the image fragment selected by the user is presented in the comparison display pane 354. In this example, the image fragment selected by the user is displayed in a center region 355 among the three display regions in the comparison display pane 354. Note that the fragment comparison unit 124 may display a region of the image fragment selected by the user in the image display pane 302. In the example in FIG. 3C, a region corresponding to the image fragment selected by the user is indicated by a dashed rectangle.

As described above, the fragment comparison unit 124 presents a plurality of reference images to the user. The plurality of reference images are displayed in the selection pane 353. In the present embodiment, a plurality of image fragments stored in the fragment storage unit 123 are displayed in the selection pane 353. Each of the plurality of image fragment is an image showing a crack and is used as a reference image. The fragment storage unit 123 will be described later.

As described above, the input acquisition unit 125 can acquired user input for selecting a reference image among the plurality of reference images presented by the fragment comparison unit 124. In this example, the user selects an image fragment from among the plurality of image fragments displayed in the selection pane 353. The user can select an image fragment by operating the mouse or the touch panel. Here, the user can select a reference image so that an attribute value of the defect shown in the reference image corresponds to an attribute value of the determination-target defect. In this example, a reference image is selected by the user from among the plurality of reference image so that the width of the crack shown in the reference image is similar to the width of the determination-target crack. For example, the user can select an image fragment from the selection pane 353 so that the width of the crack included in the image fragment displayed in the region 355 and the width of the crack shown in the selected image fragment are the same, substantially the same, or similar.

Meanwhile, in the present embodiment, the user selects two or more reference images. For example, the user can select a first reference image so that the width of the crack shown in the first reference image is smaller than the width of the determination-target crack. Furthermore, the user can select a second reference image so that the width of the crack shown in the second reference image is larger than the width of the determination-target crack. Specifically, the user can select a reference image so that the crack width of the crack shown in the reference image is slightly smaller than that of the crack included in the image fragment displayed in the region 355. Furthermore, the user can select another reference image so that the crack width of the crack shown in the reference image is slightly larger than that of the crack included in the image fragment displayed in the region 355. The two reference images selected in such a manner are displayed in regions 356 and 357 to the left and right of the region 355.

In one embodiment, the plurality of reference images each show a crack extending in an orientation corresponding to the orientation of the determination-target crack. For example, the fragment comparison unit 124 can, based on the orientation of the determination-target crack, select a plurality of reference images to be presented to the user from among the plurality of reference images stored in the fragment storage unit 123. For example, in the example in FIG. 3C, the angles of the cracks shown in the reference images displayed in the selection pane 353 are the same or substantially the same (in the sense that the difference in angle is no more than a threshold, for example) as the angle of the crack included in the image fragment selected in the selection pane 352. By aligning the orientation of the determination-target crack and the orientations of the cracks shown in the reference images in such a manner, the width of the determination-target crack and the widths of the cracks shown in the reference images can be compared easily. For example, the fragment comparison unit 124 can select reference images showing cracks extending in an orientation corresponding to the orientation of the determination-target crack from among the plurality of reference images stored in the fragment storage unit 123.

Furthermore, as illustrated in FIG. 3C, reference images may be displayed as a list in the selection pane 353 together with information of crack width values stored in the fragment storage unit 123 in association with the reference images. Furthermore, among the two selected reference images, the reference image associated with a smaller crack width may be displayed to the left of the region 355, and the reference image associated with a larger crack width may be displayed to the right of the region 355.

In the example in FIG. 3C, the reference images selected by the user are presented in the comparison display pane 354. As illustrated in FIG. 3C, the fragment comparison unit 124 can output a screen in which an image of the determination-target crack and the reference images conforming to user input are included in an aligned state. As a result of the user selecting reference images as described above, three image fragments would be arranged in ascending order of crack width in the comparison display pane 354 if the user's determination is correct. Such a display facilitates the user's determination of whether or not the reference images that the user has selected are reasonable.

Furthermore, the information addition unit 122 determines the width of the determination-target crack based on information indicating crack width associated with the selected reference images. For example, the information addition unit 122 can calculate, as the width of the determination-target crack, the average of the crack widths associated with the two or more reference images. In this example, the crack widths in the first and third image fragments from the left displayed in the comparison display pane 354 are known. Thus, the information addition unit 122 can estimate, as the crack width of the central image fragment displayed in the region 355, an intermediate value (for example, the average) of the crack widths in the first and third image fragments. In the example in FIG. 3C, the crack width in the image fragment displayed in the region 355, which is sandwiched by the reference images corresponding to the crack widths 1.0 mm and 1.4 mm in the comparison display pane 354, is estimated as 1.2 mm. The crack width value estimated in such a manner is automatically input to the input field 313.

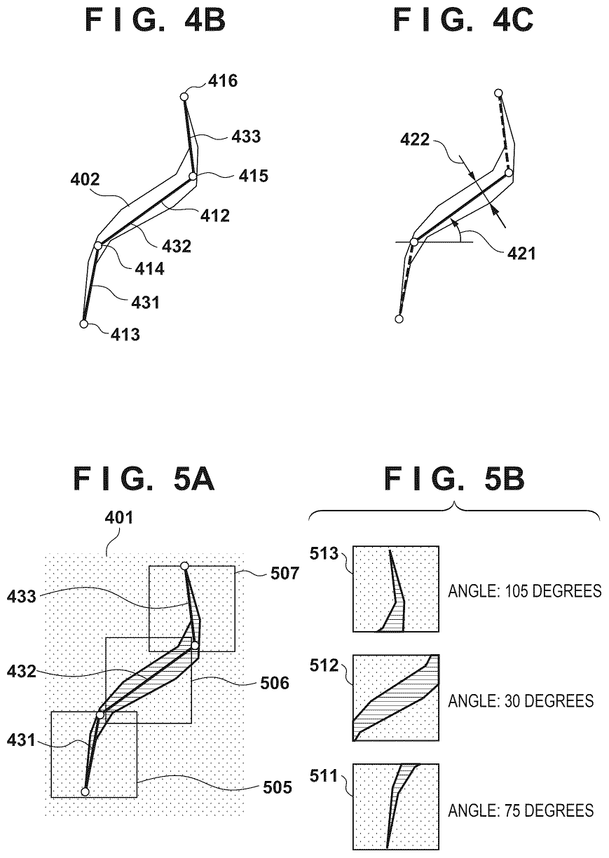

Furthermore, a method for generating image fragments from a detection result of a crack will be described with reference to FIGS. 4B and 4C, and FIGS. 5A and 5B. As described with reference to FIG. 3B, the user can specify the coordinates of points 413 to 416 along a crack 402 that the user has visually detected from an image. In this case, as illustrated in FIG. 4B, the crack is approximated by a polyline 412 having the points 413 to 416 as vertices. This polyline 412 is formed from three line segments (line segment 431 between points 413 and 414, line segment 432 between points 414 and 415, and line segment 433 between points 415 and 416) each indicating a crack. Here, the fragment generation unit 121 can determine the angle (i.e., crack orientation) of each of the three line segments. For example, as illustrated in FIG. 4C, the fragment generation unit 121 can calculate an angle 421 of the line segment 432 between points 414 and 415 based on the coordinates of the points 414 and 415. The information addition unit 122 may add, to each of the line segments 431 to 433, an attribute value, such as the angle, of the crack or line segment.

Furthermore, the fragment generation unit 121 extracts image fragments from regions of the image each containing the majority of the corresponding line segment. FIG. 5A illustrates the line segments 431 to 433 constituting the polyline 412 indicating the crack 402 so as to be superimposed on the image of the crack. The fragment generation unit 121 sets square regions 505 to 507 of the same size that each have the midpoint of the corresponding one of the line segments 431 to 433 at the center, and that each contain the majority of the corresponding one of the line segments 431 to 433. The midpoint of a line segment can be obtained from the coordinates of both ends of the line segment. The regions 505 to 507 may each contain the entirety of the corresponding one of the line segments 431 to 433. On the other hand, the regions 505 to 507 each do not need to contain the entirety of the corresponding one of the line segments 431 to 433. The regions 505 to 507 can each be set so as to contain at least the midpoint of the corresponding one of the line segments 431 to 433. Furthermore, the information addition unit 122 cuts out, from the image, the images within the set square regions 505 to 507. The images cut out in such a manner are image fragments 511 to 513 illustrated in FIG. 5B.

The information addition unit 122 can further add, to each of the image fragments 511 to 513, an attribute value relating to the crack shown in the image fragment. For example, the information addition unit 122 can add, to each of the image fragments 511 to 513, an attribute value, such as angle, relating to the crack or line segment. Specifically, the information addition unit 122 can add information indicating the angle 421 of the line segment 432 to the image fragment 512 corresponding to the line segment 432. Based on such angle information, the fragment comparison unit 124 can select the reference images to be displayed in the selection pane 353 so that the orientation of the crack shown in the image fragment of the determination-target crack and the orientation of the crack shown in each reference image correspond to one another.

### Flowchart of Processing for Determining Crack Width

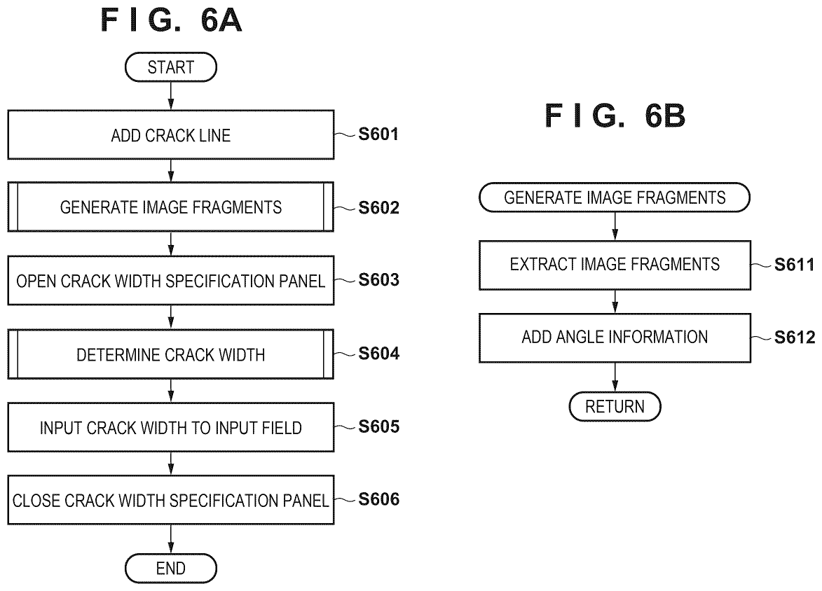

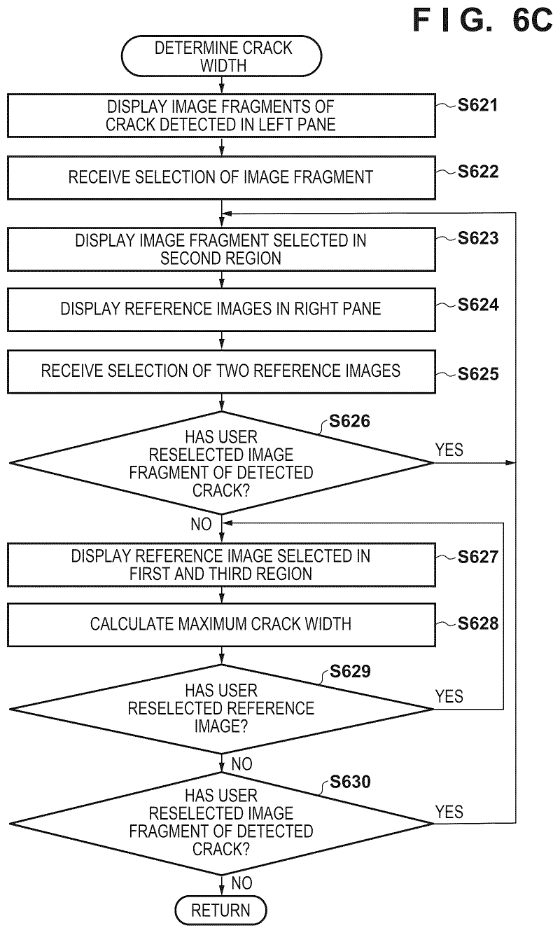

With reference to FIG. 6A, description will be provided of a control method executed by the image analysis apparatus 101 according to one embodiment to determine the crack width of a crack that has been detected by the user from an inspection target. According to this flowchart, the maximum crack width of a crack line added by the user is determined.

In step S601, the input acquisition unit 125 receives user input for adding a crack line. The crack line can be added using the UI illustrated in FIG. 3A, for example. Here, the result editing unit 114 can store information indicating the crack line added by the user in the result storage unit 115.

In step S602, the fragment generation unit 121 executes a subroutine for generating image fragments of the crack line, which is illustrated in FIG. 6B. In step S611, the fragment generation unit 121 extracts image fragments containing line segments corresponding to the crack line from the image of the inspection target as described above. In step S612, as described above, the information addition unit 122 adds information of the angle of the line segment to each of the image fragments.

In step S603, the fragment comparison unit 124 outputs a UI for determining crack width. For example, the fragment comparison unit 124 can open the specification panel 351.

In step S604, the fragment comparison unit 124 executes a subroutine for determining crack width, which is illustrated in FIG. 6C. In step S621, the fragment comparison unit 124 displays, in the selection pane 352, one or more image fragments of the crack line added by the user. In step S622, the input acquisition unit 125 receives user input for specifying the image fragment showing the crack having the largest crack width. For example, the user can select the image fragment showing the largest crack width from among the image fragments displayed in the selection pane 352. In step S623, the fragment comparison unit 124 presents the image fragment conforming to the user input acquired in step S622 to the user in the comparison display pane 354 as an image of the determination-target crack. For example, the fragment comparison unit 124 displays the image fragment conforming to the user input acquired in step S622 in the center region 355 positioned second in the comparison display pane 354.

In step S624, the fragment comparison unit 124 presents a plurality of reference images each showing a crack to the user in the selection pane 353. Here, as described above, the fragment comparison unit 124 selects the image fragments to be displayed in the selection pane 353 from among the image fragments stored in the fragment storage unit 123 in accordance with the angle of the crack shown in the image fragment conforming to the user input acquired in step S622. In step S625, the input acquisition unit 125 acquires user input for selecting two of the image fragments displayed in the selection pane 353. As described above, the user selects image fragments so that the widths of the cracks shown in the two image fragments selected by the user are close to the width of the crack shown in the image fragment conforming to the user input acquired in step S622.

In step S626, the fragment comparison unit 124 determines whether or not the user has reselected an image fragment displayed in the selection pane 352. Processing returns to step S623 if reselecting has been performed. Otherwise, processing advances to step S627.

In step S627, the fragment comparison unit 124 displays the image fragments conforming to the user input acquired in step S625 in the first region 356 and the third region 357 in the comparison display pane 354 so as to be arranged in ascending order of crack width. In step S628, the information addition unit 122 acquires, from the fragment storage unit 123, information indicating crack width added to each of the two image fragments conforming to the user input acquired in step S625. Furthermore, the information addition unit 122 calculates, as the maximum crack width of the crack line added by the user, an average of the crack widths of the two image fragments.

In step S629, the fragment comparison unit 124 determines whether or not the user has reselected an image fragment displayed in the selection pane 353. Processing returns to step S627 if reselecting has been performed. Otherwise, processing advances to step S630. In step S630, the fragment comparison unit 124 determines whether or not the user has reselected an image fragment displayed in the selection pane 352. Processing returns to step S623 if reselecting has been performed. Otherwise, the subroutine in step S604 is terminated.

In step S605, the information addition unit 122 automatically inputs the maximum crack width calculated in step S628 to the input field 313. In step S606, the fragment comparison unit 124 closes the specification panel 351. Here, the result storage unit 115 can store the value input to the input field 313 as the maximum crack width of the crack line added by the user in step S601.

According to the above-described embodiment, the width of a determination-target crack can be determined by a simple operation of selecting reference images. According to such a configuration, the determination of crack width can also be performed easily by operating a mouse or a touch panel, similarly to the addition or deletion of a crack line. Thus, user workload can be reduced. Furthermore, the meticulous work of reading crack width by aligning a crack scale with a crack, and the input of a crack width value using a keyboard become unnecessary. Thus, the operation of determining crack width can be performed easily even in a situation in which the means for input is limited, such as when a tablet PC is being used at an inspection site.

In particular, in the above-described embodiment, the user selects two or more reference images to determine the width of a determination-target crack. According to such a configuration, it can be expected that the width of the crack can be determined with higher accuracy. For example, cracks may have various shapes in a captured image. For example, in an image of a determination-target crack, the crack may have non-uniform width, or may not have a perfectly straight shape. Even if the user cannot confidently select a reference image corresponding to the image of the determination-target crack due to such reasons, the width of the crack can be accurately determined according to the above-described configuration.

Furthermore, in one embodiment, reference images of cracks extending in orientations corresponding to the orientation of the determination-target crack are presented to the user as described above. Thus, the user can easily select reference images corresponding to the image of the determination-target crack. Furthermore, in one embodiment, image fragments are generated from an image of the inspection target. These image fragments can be generated so that each image fragment corresponds to one line segment, as illustrated in FIGS. 5A and 5B. Similarly, each reference image may also correspond to one line segment. Such a configuration facilitates the comparison between an image fragment and reference images.

### Image Fragment Database

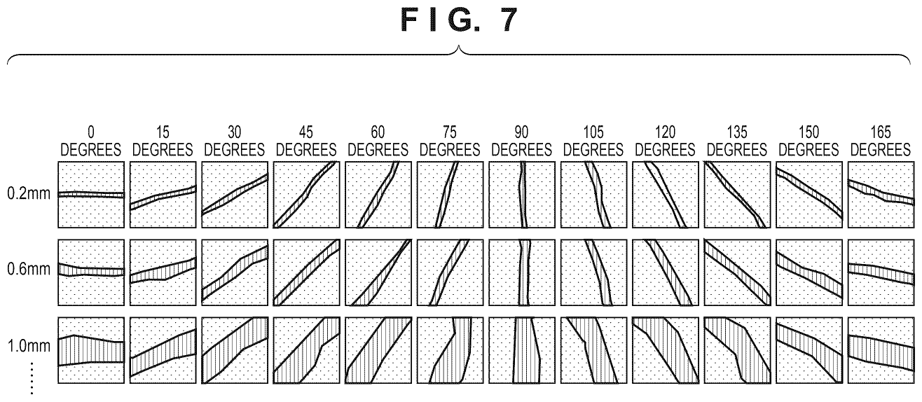

As described above, the fragment storage unit 123 can store reference images, which are image fragments showing cracks. The fragment storage unit 123 functions as an image fragment database that stores such image fragments. FIG. 7 illustrates an example of image fragments stored in the image fragment database. Information indicating crack angle and information indicating crack width are added to each image fragment.

The method for generating image fragments to be stored in the fragment storage unit 123 is not particularly limited. For example, when the user manually adds a crack line, image fragments can be stored in the fragment storage unit 123. That is, the fragment storage unit 123 can store an image of a determination-target crack as a reference image in association with information indicating the width of the crack. Specifically, after the processing according to FIGS. 6A-6C is executed, the fragment storage unit 123 can store the image fragment conforming to the user input acquired in step S622 in association with the angle of the crack shown in the image fragment and the crack width calculated in step S628. However, if the user adds a crack line but does not determine crack width, only angle values are added to image fragments as attribute values, and crack width values remain unknown.

Furthermore, image fragments showing cracks of various angles and widths may be generated based on images of inspection targets and detection results from the past. The fragment storage unit 123 can store such image fragments in the database. The images of inspection targets and detection results from the past may be training images and ground truth data for an AI model used by the image analysis unit 113 for image analysis. Such ground truth data may be input manually. Furthermore, the images of inspection targets and detection results from the past may be images of inspection targets that have been subjected to editing work by the user and detection results determined as a result of the editing work. Such editing work can be carried out using an appropriate UI. In such cases, based on a crack line indicated by a detection result, image fragments can be generated as described above with reference to FIGS. 4B and 4C, and FIGS. 5A and 5B. Such generation of image fragments may be executed by the fragment generation unit 121 or by a different processing unit or apparatus.

Furthermore, image fragments may be generated according to a known image processing method such as AI detection processing. As illustrated in FIG. 4A, the region of a crack 402 and concrete in the background 401 in an image of an inspection target can be separated from one another. Furthermore, as illustrated in FIG. 4B, the crack 402 can be approximated using a polyline 412 constituted from points 413 to 416. Furthermore, attribute values (for example, crack angle and width) of each of the line segments 431 to 433 can also be determined. For example, crack width 422 illustrated in FIG. 4C can be determined by executing image processing on the crack 402. The attribute values determined in such a manner can be added to image fragments 511 to 513 corresponding to the crack 402 that have been generated as illustrated in FIGS. 5A and 5B. Such generation of image fragments and determination of attribute values may be executed by the fragment generation unit 121 or the image analysis unit 113, or by a different processing unit or apparatus.

Note that an image is provided with resolution information expressed in the unit mm/pixel. This resolution indicates the number of millimeters in reality to which one pixel in the image corresponds. A standard image resolution (for example, 0.5 mm/pixel for bridges, and 2.0 mm/pixel for tunnels) may be determined in advance in accordance with the inspection-target object. In such a case, images are captured so that such an image resolution is met. On the other hand, inspection targets with high priority may be image-captured with higher definition than the standard image resolution. As described above, the image fragments stored in the fragment storage unit 123 are referred to upon determining crack width. Thus, it is desirable that images of inspection targets and the image fragments have the same resolution. Thus, the fragment comparison unit 124 can execute enlargement or size reduction processing on images so that images of inspection targets (for example, the image fragment displayed in region 355) and image fragments displayed in the selection pane 353 have the same resolution.

In the example in FIG. 7, image fragments are stored in the form of a table in which angles are plotted in 15-degree increments in the horizontal direction and crack widths are plotted in 0.4-mm increments in the vertical direction. In this case, the fragment comparison unit 124 can select, as an image fragment to be presented to the user, an image fragment that is associated with the angle closest to the angle of the determination-target crack. The number of image fragments showing cracks having the same angle and width is not limited to one. A plurality of image fragments showing cracks having the same angle and width may be stored in the fragment storage unit 123.

Furthermore, new image fragments may be generated by executing image processing on an image fragment. Such a method makes it possible to include the number of image fragment samples. Rotation and inversion processing can be mentioned as examples of the image processing. That is, the fragment storage unit 123 can store, as reference images, images obtained by executing rotation processing and/or inversion processing on an image showing a crack. In this example, image fragments are raster images. Accordingly, image quality may be reduced by rotation and transformation processing. However, image quality is not reduced even if rotation in 90-degree increments or inversion in the top-bottom or left-right direction is executed. By executing such image processing, the fragment generation unit 121 can increase the number of image fragment samples while preventing a reduction in image quality.

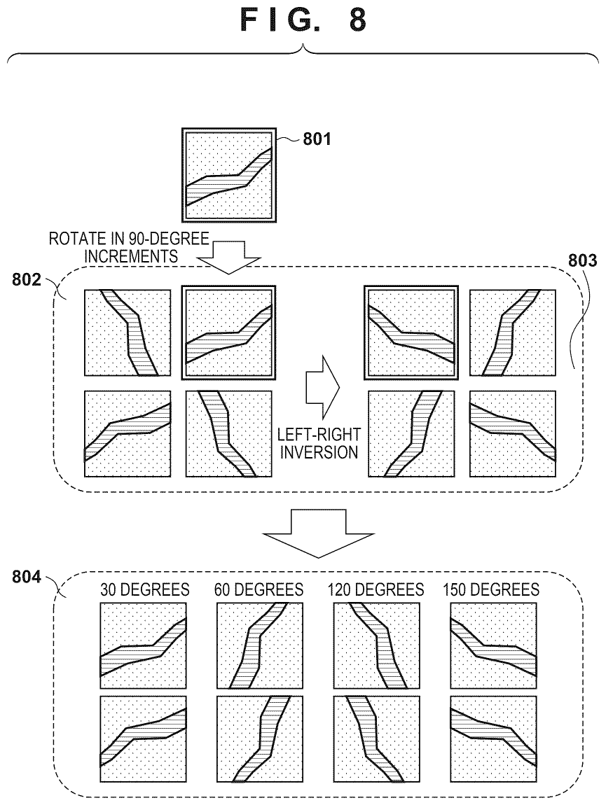

For example, an image fragment 801 showing a crack line having a 30-degree angle is illustrated in FIG. 8. A total of four image fragments 802 can be obtained by rotating this image fragment 801 by 90 degrees, 180 degrees, and 270 degrees. Four more image fragments 803 can be obtained by further executing left-right inversion processing on the four image fragments 802. In such a manner, a total of eight image fragments 804 can be generated based on the image fragment 801 without image degradation. The eight image fragments 804 include two each of image fragments showing crack lines having an angle of 30 degrees, 60 degrees, 120 degrees, and 150 degrees.

### Determination of Crack Width of Existing Crack Line

Up to this point, with reference to the UIs in FIGS. 3A to 3C, description has been provided of a method for determining the maximum crack width of a crack line when the user manually adds a crack line for a crack that was not detected by image analysis. On the other hand, the maximum crack width of a crack detected by image analysis may be determined. For example, the user can correct the maximum crack width of an existing crack that has been detected by image analysis.

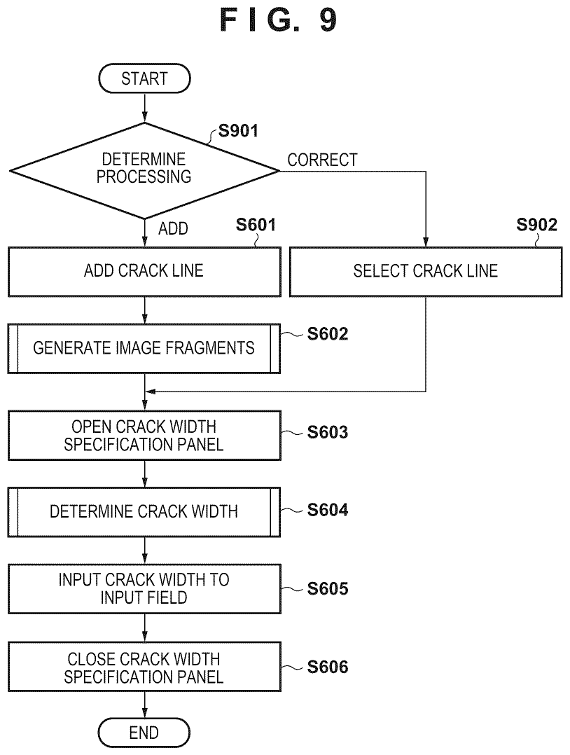

FIG. 9 is a flowchart of an information processing method executed by the image analysis apparatus 101 according to one embodiment to determine crack width. The processing illustrated in FIG. 9 can be executed in place of the processing illustrated in FIG. 6A. In the flowchart illustrated in FIG. 9, an operation of correcting the maximum crack width of an existing crack is taken into consideration.

In step S901, the result editing unit 114 determines which of the following processing is to be executed: processing for adding a new crack line; and processing for correcting the crack width of an existing crack. If a new crack line is to be added, processing advances to step S601. If crack width is to be corrected, processing advances to step S902. For example, processing can advance to step S601 if the user presses the add button 311. In this case, the processing in steps S602 to S606 is executed as already described above. Alternatively, processing can advance to step S902 if the user presses a crack-width edit button (unillustrated). In this case, in step S902, the result editing unit 114 receives user input for specifying a crack line. For example, the user can specify a crack line corresponding to the crack to be edited in the image display pane 302. In this case, in steps S602 to S606, processing for determining the maximum crack width of the crack line specified in step S902 is executed.

In the above-described embodiment, the input acquisition unit 125 receives user input for specifying the image fragment showing the crack having the largest crack width in step S622. The input acquisition unit 125 can accept similar user input also in a case in which the crack width of an existing crack is to be corrected. The correction of maximum crack width implies that the crack width before correction was incorrectly determined. Such a configuration can reduce the risk of the user being misled by an incorrect crack width determination result upon examining an image fragment corresponding to the largest crack width.

On the other hand, in step S622, the fragment comparison unit 124 may automatically select an image fragment without user input. For example, the fragment comparison unit 124 may select one of the image fragments displayed in the selection pane 352. In one embodiment, the fragment comparison unit 124 selects, as a default choice of an image fragment, an image fragment estimated to show the largest crack width among a plurality of image fragments. Such a configuration can reduce user workload. Furthermore, such a configuration can meet the needs of checking the cause of erroneous detection. For the crack selected in step S902, the fragment generation unit 121 can generate, in advance, image fragments and information indicating the crack widths therein. Accordingly, the fragment comparison unit 124 can automatically select the image fragment exhibiting the largest crack width among the image fragments corresponding to the selected crack line.

Furthermore, in step S625, the fragment comparison unit 124 may automatically select reference images without user input. For example, the fragment comparison unit 124 may select two of the image fragments displayed in the selection pane 353. In one embodiment, the fragment comparison unit 124 selects, as default choices of two or more reference images, reference images selected from among the plurality of reference images so that the widths of the cracks shown in the reference images correspond to the estimated width of the determination-target crack. For example, the fragment comparison unit 124 can select a reference image showing a crack having slightly smaller width than the width of the crack shown in the image fragment selected in step S622. Furthermore, the fragment comparison unit 124 can select a reference image showing a crack having slightly larger width than the crack width shown in the image fragment selected in step S622. Such a configuration can reduce user workload.

In such a configuration, the user performs, as necessary, an operation for reselecting an image fragment in the selection pane 352 or 353 in a state in which image fragments corresponding to a result of detection by the image analysis processing using AI or the like have been automatically selected. In this case, the operation for correcting crack width is completed by prompting the user to perform the operation of reselecting an image fragment. Thus, the number of operation steps to be performed by the user can be reduced.

Note that the above-described automatic selection of image fragments in steps S622 and S625 may be executed when the user adds a new crack line. For example, when the user adds a new crack line, the image analysis unit 113 or the fragment generation unit 121 can estimate, by image analysis, the widths of the cracks shown by the image fragments generated so as to correspond to the added crack line. The fragment comparison unit 124 may select image fragments from the selection panes 352 and 353 based on the result of such estimation of crack widths.

### Another Example of UI Displaying Image Fragments

In FIG. 3C, image fragments selected from the selection panes 352 and 353 are arranged in a single horizontal line in the comparison display pane 354. However, the form in which image fragments are displayed is not particularly limited.

For example, the regions 355 to 357 are arranged horizontally in the example in FIG. 3C. However, the image fragments may be arranged vertically, laterally, or diagonally. Furthermore, in the example in FIG. 3C, the regions 355 to 357 are arranged from the left to the right in ascending order of crack width. However, the image fragments may be arranged in any direction in ascending or descending order of crack width.

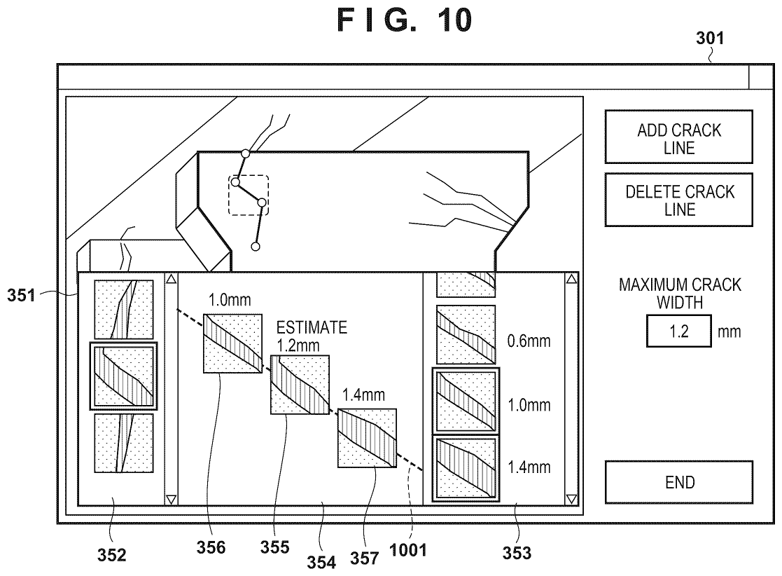

Furthermore, on the screen, an image of a determination-target crack and reference images conforming to user input may be arranged along the orientation of the determination-target crack. For example, image fragments may be arrayed based on crack-angle information added to the image fragments. FIG. 10 illustrates an example of such a UI. In the center region 355 of the comparison display pane 354 in the specification panel 351, an image fragment of the determination-target crack selected from the selection pane 352 is displayed. Furthermore, reference images selected from the selection pane 353 are displayed in the regions 356 and 357 on both sides of the region 355. Here, the region 356, region 355, and region 357 are aligned along a guide line 1001. The angle of this guide line 1001 is the same as the angle of the crack shown in the image fragment of the determination-target crack selected from the selection pane 352. Note that the guide line 1001 may or may not be visible. According to such a configuration, cracks that are shown in image fragments are arranged along one straight line. Due to the characteristics of human visual perception, such a configuration enables differences in crack width to be visually perceived more sensitively.

Furthermore, in the example in FIG. 3C, the region 355 of one image fragment with unknown crack width is sandwiched between the regions 356 and 357 of two image fragments with known crack width. However, the number of image fragments with known attribute values that are to be displayed can be determined, as appropriate. For example, one image fragment with known crack width may be arranged next to an image fragment with unknown crack width. Also, one image fragment with unknown crack width and two or three or more image fragments with known crack width may be arranged on a straight line. Also, one image fragment with unknown crack width and two or more image fragments with known crack width may be arranged on the circumference of a circle. In such a manner, an appropriate form of display allowing image fragments to be easily compared visually can be adopted. Note that, in the above-described embodiment, the intermediate value of attribute values of image fragments that are reference images is used as the attribute value of the determination target. The method for calculating the attribute value of the determination target is not particularly limited. For example, a weighted average of attribute values of image fragments that are reference images may be calculated as the attribute value of the determination target. Furthermore, the intermediate value may be that on a logarithmic scale.

Furthermore, in the example in FIG. 3C, image fragments are selected from the selection panes 352 and 353 arranged to the left and right of the comparison display pane 354. However, the method for selecting image fragments is not limited to this example. For example, a list of image fragments corresponding to each of the regions 355 to 357 may be displayed. For example, in the list of image fragments corresponding to each of the regions 356 and 357, a plurality of different image fragments corresponding to the same crack width or different crack widths may be displayed vertically. Furthermore, an image fragment may be selected by an operation of a slider associated with this list, a scroll operation on a mouse, or a flick operation on a touch panel. According to such operations, the selected image fragment changes successively.

### Other Embodiments

In the above-described embodiment, the image fragments stored in the fragment storage unit 123 are extracted from images of inspection targets from the past or training images for an AI model. In such a manner, the fragment storage unit 123 can store image fragments extracted from captured images. Furthermore, the fragment storage unit 123 may store image fragments generated by applying image processing to captured images. On the other hand, the fragment storage unit 123 may store image fragments showing cracks that have been artificially generated by a different method. Binary images with clear contrast such as a crack scale, grayscale images having a blur or shake corresponding to resolution intentionally added thereto, and images generated based on a color palette can be mentioned as examples of artificially generated images. Images generated using AI can also be mentioned as another example of artificially generated images. Such an AI can be trained using images showing actual cracks.

Furthermore, the fragment storage unit 123 may be configured so as to store image fragments meeting a predetermined criterion and so as not to store image fragments not meeting the predetermined criterion. For example, in image fragments generated based on images of inspection targets from the past, cracks may not pass through the center of the image fragments or may branch out. Such image fragments are unsuitable for comparison with a determination-target image fragment. Furthermore, crack width information or angle information added to image fragments may not be correct. Such image fragments may be excluded in advance. For example, the fragment generation unit 121 may determine whether or not image fragments meet the predetermined criterion, and store, in the fragment storage unit 123, only image fragments meeting the predetermined criterion. Also, the fragment generation unit 121 may delete image fragments not meeting the predetermined criterion among image fragments stored in the fragment storage unit 123.

For example, the fragment generation unit 121 may determine whether or not image fragments meet the predetermined criterion by performing pattern matching between the image fragments and a simple standard image reproducing a crack that meets or does not meet the criterion. Also, the fragment generation unit 121 may determine whether or not image fragments meet the predetermined criterion based on the degree of overlap between the image fragments and a straight line that is inclined so as to have a predetermined angle. Furthermore, the fragment generation unit 121 may use AI to determine whether or not image fragments meet the predetermined criterion. As another method, reference images stored in the fragment storage unit 123 may be deleted based on user input. For example, a button for deleting a displayed reference image from the fragment storage unit 123 may be provided on a UI such as that illustrated in FIG. 3C for comparing image fragments.

Furthermore, it is also conceivable to employ other measures for reducing the effect of inappropriate image fragments being used as reference images during the work by the user of determining crack width. For example, a component (for example, a reload button) for replacing reference images may be provided on a UI such as that illustrated in FIG. 3C for comparing image fragments. Another reference image is displayed if the user operates this button in a case in which an inappropriate image fragment is presented as a reference image. The other reference image may show a crack having the same angle and width as the previously displayed reference image. So that such processing can be executed, the fragment storage unit 123 can store a plurality of image fragments showing cracks having the same angle and width.

Furthermore, the fragment comparison unit 124 may execute image processing such as resolution conversion processing or color correction processing on image fragments to be presented to the user (image of determination target and/or reference images). For example, the fragment comparison unit 124 can execute processing for normalizing differences in brightness, hue, and/or contrast on image fragments. Furthermore, the fragment comparison unit 124 may execute processing for adjusting brightness, hue, and/or contrast on reference images so that the reference images are in line with the image of the determination-target crack. Such processing facilitates visual comparison of image fragments.

In the above-described embodiment, image fragments are square shaped. However, the shape of image fragments is not particularly limited. For example, image fragments may be rectangular, circular, triangular, or hexagonal, or may not have a fixed shape. So that image fragments can be easily compared with one another, a shape allowing image fragments to be easily arranged close to one another can be adopted.

Furthermore, in the above-described embodiment, one maximum crack width is determined for one crack (for example, the crack 332). However, a crack width may be determined for each of a plurality of portions of a single crack. For example, an independent crack width may be determined for each of the plurality of line segments 431 to 433 of the polyline representing the crack 332. In this case, for each of the image fragments displayed in the selection pane 352, a crack width can be determined according to the method of selecting reference images from the selection pane 353 as described above on the UI illustrated in FIG. 3C, for example.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-027873, filed Feb. 27, 2024, which is hereby incorporated by reference herein in its entirety.

What is claimed is:

1. An image analysis apparatus comprising one or more memories storing instructions and one or more processors that execute the instructions to:
present an image of a determination-target crack detected from an inspection target to a user together with a plurality of reference images each showing a crack;
acquire user input for selecting two or more reference images among the plurality of reference images; and
determine a width of the determination-target crack based on information indicating crack widths associated with the two or more reference images.

2. The image analysis apparatus according to claim 1,
wherein the plurality of reference images each show a crack extending in an orientation corresponding to an orientation of the determination-target crack.

3. The image analysis apparatus according to claim 1 further comprising
a storage that stores a plurality of reference images together with information indicating orientations and widths of cracks shown in the reference images,
wherein the one or more processors execute the instructions to, based on an orientation of the determination-target crack, select the plurality of reference images to be presented to the user from among the plurality of reference images stored in the storage.

4. The image analysis apparatus according to claim 1,
wherein the two or more reference images are selected by the user from among the plurality of reference images so that widths of cracks respectively shown in the two or more reference images are similar to the width of the determination-target crack.

5. The image analysis apparatus according to claim 4,
wherein a first reference image among the two or more reference images is selected by the user so that a width of a crack shown in the first reference image is smaller than the width of the determination-target crack, and
a second reference image among the two or more reference images is selected by the user so that a width of a crack shown in the second reference image is larger than the width of the determination-target crack.

6. The image analysis apparatus according to claim 1,
wherein the one or more processors execute the instructions to select, as default choices of the two or more reference images, reference images selected from among the plurality of reference images so that widths of cracks shown in the reference images correspond to an estimated width of the determination-target crack.

7. The image analysis apparatus according to claim 1,
wherein the one or more processors execute the instructions to generate, from an image of the inspection target, a plurality of image fragments each containing a part of a crack detected from the inspection target.

8. The image analysis apparatus according to claim 7,
wherein the one or more processors execute the instructions to present, as the image of the determination-target crack, an image fragment selected by the user among the plurality of image fragments.

9. The image analysis apparatus according to claim 8,
wherein the image fragment selected by the user is an image fragment selected by the user as an image fragment showing a crack with largest width among the plurality of image fragments.

10. The image analysis apparatus according to claim 8,
wherein the one or more processors execute the instructions to select, as a default choice of the image fragment, an image fragment estimated to show a crack with largest crack width among the plurality of image fragments.

11. The image analysis apparatus according to claim 1,
wherein the one or more processors execute the instructions to detect a crack from an image of the inspection target by image analysis processing.

12. The image analysis apparatus according to claim 11,
wherein the one or more processors execute the instructions to acquire user input indicating a position of a crack additionally detected by the user in the image of the inspection target, and
the determination-target crack is the crack detected by the user.

13. The image analysis apparatus according to claim 1 further comprising
a storage that stores a plurality of reference images,
wherein the storage stores the image of the determination-target crack as a reference image in association with information indicating the width of the crack.

14. The image analysis apparatus according to claim 13,
wherein the storage stores, as reference images, one or more images obtained by executing rotation processing and/or inversion processing on an image showing the crack.

15. The image analysis apparatus according to claim 1,
wherein the one or more processors execute the instructions to output a screen in which the image of the determination-target crack and the two or more reference images conforming to the user input are included in an aligned state.

16. The image analysis apparatus according to claim 15,
wherein, on the screen, the image of the determination-target crack and the two or more reference images conforming to the user input are arranged along an orientation of the determination-target crack.

17. The image analysis apparatus according to claim 1,
wherein the one or more processors execute the instructions to calculate, as the width of the determination-target crack, an average of the crack widths associated with the two or more reference images.

18. An image analysis apparatus comprising one or more memories storing instructions and one or more processors that execute the instructions to:
present an image of a determination-target defect detected from an inspection target to a user together with a plurality of reference images each showing a defect;
acquire user input for selecting a reference image from among the plurality of reference images; and
determine an attribute value of the determination-target defect based on a defect attribute value associated with the reference image conforming to the user input,
wherein each of the plurality of reference images is an image of a defect extracted from a captured image, and is associated with information indicating an attribute value of the defect.

19. An image analysis method comprising:
presenting an image of a determination-target crack detected from an inspection target to a user together with a plurality of reference images each showing a crack;
acquiring user input for selecting two or more reference images among the plurality of reference images; and
determining a width of the determination-target crack based on information indicating crack widths associated with the two or more reference images.

20. A non-transitory computer-readable medium storing a program executable by a computer to perform a method comprising:
presenting an image of a determination-target crack detected from an inspection target to a user together with a plurality of reference images each showing a crack;
acquiring user input for selecting two or more reference images among the plurality of reference images; and
determining a width of the determination-target crack based on information indicating crack widths associated with the two or more reference images.
